(19) United States
(12) Patent Application Publication
(10) Pub. No.: US 2006/0136901 A1
(43) Pub. Date: Jun. 22, 2006

(54) MOBILE FINANCIAL TRANSACTION MANAGEMENT SYSTEM AND METHOD

(75) Inventor: Paul Henry Nichols, Raleigh, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 10/905,256

(22) Filed: Dec. 22, 2004

(51) Int. Cl. G06F 9/44

(52) U.S. Cl. 717/169

(57) ABSTRACT

A method of automatically recording financial transactions into a personal finance database. A method of exchanging personal financial data between a portable wireless device running a mobile financial application software program and a master financial application software program residing on a separate computer is described. The mobile financial application program stores mobile e-commerce transactions conducted on the portable wireless device. The mobile financial application program establishes a connection with the master financial application program either automatically or upon user initiation. Once a connection is established, financial data is exchanged between the mobile and master financial applications thereby keeping them synchronized and up to date. The connection between the mobile and master financial application program includes a wireless network and can also include a wired network. Alternatively, the connection between the mobile and master financial application programs can be a direct connection that does not include a network.

### BACKGROUND

Mobile electronic commerce is a rapidly developing application that allows users to pay for goods and/or services using portable wireless devices such as mobile phones. The basic concept calls for the portable wireless device to be provisioned with “currency”. The currency can be a link to a credit card account, a bank account, or the like. The portable wireless device would then use short range RF, Bluetooth™ or IR technologies to communicate with a vendor's point-of-sale (POS) device to conduct a transaction. Transactions can include virtually anything from paying for gas at a filling station, settling a check at a restaurant, to purchasing a hot dog at a baseball game.

Many people also use some type of financial software application to keep track of various personal financial issues. Some of these include account balance information, home budget information, and portfolio status information. The financial software application is typically resident on and executed from a personal computer. In addition, the financial software manufacturer often maintains a secure web-site for customer use that allows a customer to upload and securely post personal financial data. This allows the user to access their personal financial data from somewhere other than their home personal computer.

While the financial software application is adept at tracking and monitoring specific financial data, the data itself still needs to be input into the software. Sometimes data can be input from other sources using an import feature. The import feature typically allows for wholesale importation of data into the financial application software provided it is formatted appropriately. Other data can be manually input through a graphical user interface (GUI) that acts as an interface between the user and the financial application software. Manual input is very often a laborious and tedious process that is prone to human error.

If a portable wireless device mobile e-commerce user is also a person that utilizes a financial software application to track and monitor financial data, then the transactions conducted on the portable wireless device need to be entered into and recorded by the financial software application. Currently this entails waiting until the user has direct access to his personal computer and manually entering the transactions into the financial software application.

What is needed is a means for automatically recording transaction data in a local copy of the user's financial database that resides on a wireless device and then transmitting the transaction data from a remote location, (if necessary) to a financial software application without having to manually enter the transactions into the financial software application.

### SUMMARY

The present invention describes a method, system, and computer program product for exchanging personal financial data between a portable wireless device running a mobile financial application software program and a master financial application software program residing on a separate computer. The mobile financial application software program stores mobile e-commerce transactions conducted on the portable wireless device. The mobile financial application software program establishes a connection with the master financial application software program either automatically or upon user initiation. Once a connection is established, financial data is exchanged between the mobile financial application software program and the master financial application software program thereby keeping the mobile and master financial applications synchronized and up to date.

The connection between the mobile financial application software program and the master financial application software program includes a wireless network and a can also include a wired network such as the Internet. Alternatively, the connection between the mobile financial application software program and the master financial application software program can be a direct connection that does not include a network such as Bluetooth™, 802.11x, Ir, or cable such as RS232 or USB.

### BRIEF DESCRIPTION OF THE DRAWINGS

FIG. 1 is a network diagram illustrating the environment in which the present invention can be practiced.

FIG. 2 is a flowchart illustrating the logical flow for moving financial transaction data between a portable wireless device and a financial software application.

FIG. 3 is message diagram describing a data transfer to set up a connection between a portable wireless device and a financial software application.

FIG. 4 is message diagram describing a data transfer to exchange financial data between a portable wireless device and a financial software application.

FIG. 5 is message diagram describing a data transfer to set up a connection between a portable wireless device and a financial software application using an intermediary server.

FIG. 6 is message diagram describing a data transfer to exchange financial data between a portable wireless device and a financial software application using an intermediary server.

### DETAILED DESCRIPTION

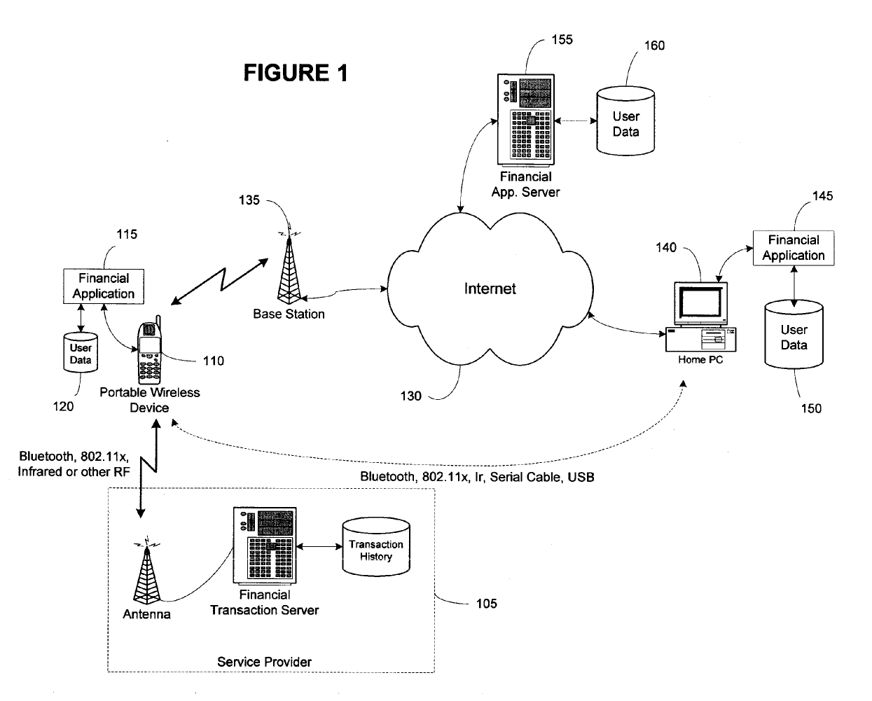

FIG. 1 is a network diagram illustrating the environment in which the present invention can be practiced. A portable wireless device 110 such as a mobile phone contains a version of a financial application software program 115 and associated data storage 120. The portable wireless device 110 is communicable with a network 130 such as the Internet via a base station 135. The network, in turn, can communicate with a home personal computer 140 that hosts a financial software application 145 and associated storage 150. The network can also communicate with a financial application server 155 maintained by the financial software application manufacturer in the form of a web-site or the like. The financial application server 155 is further associated with a data storage device 160.

There are multiple communication paths for exchanging financial data between the financial software application 115 on the portable wireless device 110 and the financial software application 145 on the personal computer 140. One path would allow the portable wireless device 110 to communicate with the home personal computer 140 via base station 135 and network 130 using an “always on” network connection, preferably broadband. Another path would use the financial application server 155 maintained by the financial software application manufacturer as an intermediary between the portable wireless device 110 and home personal computer 140.

If the portable wireless device 110 is in close proximity to the home personal computer 140, then a direct connection between the portable wireless device 110 and the home personal computer 140 can be set up via a Bluetooth™ RF connection, an IR connection, or a cabled connection like USB. With one of these connections, data can be exchanged directly from portable wireless device 110 to home personal computer 140 and vice versa.

The portable wireless device 110 is also communicable with a variety of service or goods providers 105. The service or goods providers are equipped to conduct an e-commerce transaction with the portable wireless device 110. An e-commerce transaction is one which is achieved wirelessly between the portable wireless device 110 and a service or goods providers 105 such that no actual physical contact (credit or bank card swipe) or exchange of currency is required.

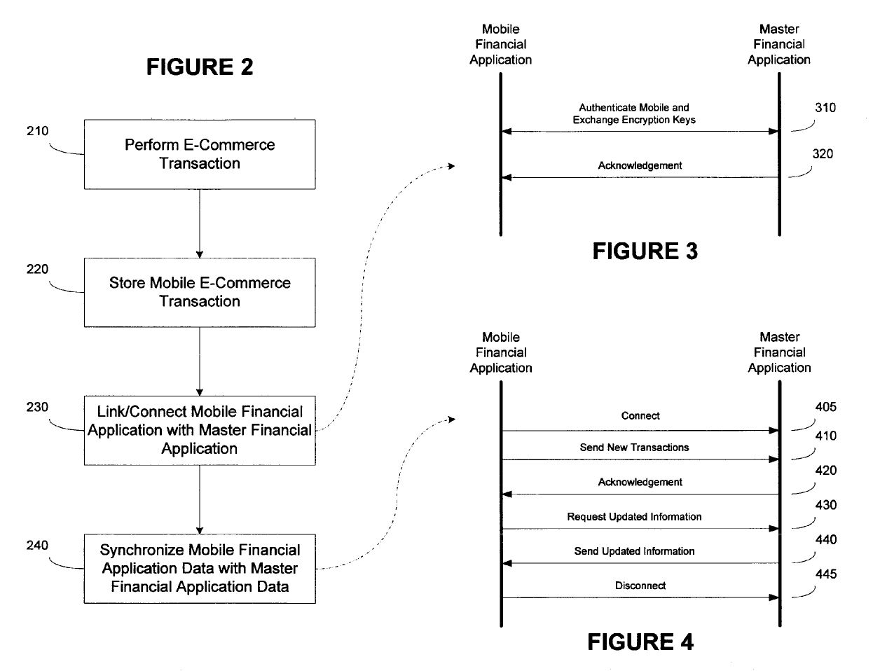

FIG. 2 is a flowchart illustrating the logical flow for moving financial transaction data between a portable wireless device and a financial software application. Because the e-commerce system and the personal financial software are integrated, during the process of conducting a mobile e-commerce transaction, the mobile device may optionally display budget information that would help the user make a purchase decision. For example, the amount spent (month to date or year to date) in certain budget categories that are related to the pending purchase decision. The process of the present invention begins at the conclusion of a mobile e-commerce transaction. Upon completion of a mobile e-commerce transaction 210 the portable wireless device, via a mobile financial application, stores 220 the relevant transaction information in a financial transaction record. A financial transaction record is produced upon completion of an e-commerce transaction. The table below illustrates the type of information that might be found inside a financial transaction record. Other data may be included in a financial transaction record. The table below is merely an exemplary illustration.

| Acct Type | Acct Name | Acct No. | Payee | Item Desc. | Cost | Time/Date |
|---|---|---|---|---|---|---|
| Credit | First National | 123456789 | Borders | Books | $ 45.34 | Dec. 15, 2004 05:37 PM |
| Debit | First Union | 987654321 | Kroger | Groceries | $ 56.76 | Dec. 15, 2004 06:45 PM |

The mobile device compares the financial transaction record with a history of transactions stored in the mobile's financial database and can determine a budget category for the transaction based on information such as the payee, item description, and cost. This information is displayed to the user who is given the option to record the transaction, change the budget category, or not record the transaction. The user can select a setting so that transactions are automatically categorized and recorded without prompting the user. The financial transaction record is formatted to be compatible with a master financial application that resides on a host computer elsewhere (typically a home personal computer).

The mobile financial application can be configured to link or connect to the master financial application 230 for purposes of exchanging data with one another. Once a link or connection has been established, data between the mobile and master financial applications can be exchanged 240. The process of exchanging information 240 is typically referred to as “synchronizing” the data.

Data synchronization can be a scheduled event that takes place automatically or a manual event that occurs upon user initiation. In addition, the user has control over the type of data to be synchronized and the frequency of synchronization. For instance, the user can program the mobile financial application to synchronize with the master financial application on a daily basis in order to “upload” the day's mobile e-commerce transactions to the master financial application. Data types could include bank transactions, credit card transactions, portfolio updates, etc.

FIG. 3 is a message diagram describing a data transfer to set up a connection between a portable wireless device and a financial software application. The user of the mobile financial application, via a graphical user interface (GUI) or a menu system selects an option to find and link with the master financial application. This causes a message to be sent from the mobile financial application to the master financial application that contains encrypted authentication data 310 uniquely identifying the mobile financial application as the source of the request. The master financial application receives and processes the message to verify the source. Upon verification an acknowledgement can be returned 320 to the mobile financial application. There is now a connection between the mobile financial application and the master financial application that can accommodate data transfers.

FIG. 4 is a message diagram describing a data transfer to exchange financial data between a portable wireless device and a financial software application. Once the connection between the mobile financial application and the master financial application has been established 405, the mobile financial application can send new or recent transactions 410 to the master financial application. The master financial application can reply with an acknowledgement message 420 if desired. Another request the mobile financial application can make is for updated information 430. This could be a full synchronization to re-align the databases of the mobile and master financial applications, or a partial synchronization of selected data. Upon receipt of a request for updated data the master financial application packages and sends the requested data 440 back to the mobile financial application. After all requests have been completed the mobile will terminate the connection with the master financial application by performing a disconnect operation 445 to end the secure connection.

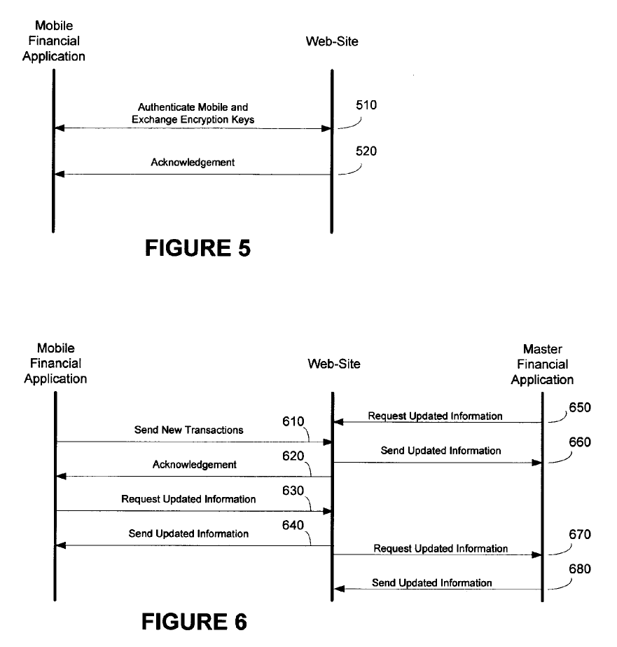

FIG. 5 is a message diagram describing a data transfer to set up a connection between a portable wireless device and a financial software application using an intermediary server. The user of the mobile financial application, via a graphical user interface (GUI) or a menu system selects an option to find and link with the master financial application. This causes a message to be sent from the mobile financial application to an intermediate server on the network maintained and operated by the financial application software manufacturer in the form of a web-site, for instance. The intermediate server is communicable with both the mobile financial application and the master financial application via a web or Internet connection. The intermediate server and its associate databases allow the financial application software user to maintain a copy of their data on the web-site that is securely accessible. The web-site data is periodically updated or synchronized with the master financial application. The mobile financial application can access the web-site using encrypted authentication data 510 uniquely identifying the mobile financial application as the source of the request. The web-site, after receiving and processing the message to verify the source, then returns an acknowledgement 520 that a connection has been established.

FIG. 6 is a message diagram describing a data transfer to exchange financial data between a portable wireless device and a financial software application using an intermediary server. Once the connection between the mobile financial application and the web-site has been established, the mobile financial application can send new or recent transactions 610 to the web-site. The web-site can reply with an acknowledgement message 620 if desired. Another request the mobile financial application can make is for updated information 630. This could be a full synchronization to re-align the databases of the mobile financial application and web-site, or a partial synchronization of selected data. Upon receipt of a request for updated data the web-site packages and sends the requested data 440 back to the mobile financial application. Bear in mind that the web-site is also communicable with the master financial application so that any updates between the mobile financial application and the web-site can be repeated between the web-site and the master financial application 650, 660, 670, 680. The mobile/web-site requests are independent of the web-site/master application requests and the master-app/web-site requests.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

What is claimed is:

1. A method of exchanging personal financial data between a portable wireless device running a mobile financial application software program and a master financial application software program residing on a separate computer, the method comprising:
storing mobile e-commerce transactions using the mobile financial application software program;
establishing a connection between the mobile financial application software program and the master financial application software program; and
exchanging financial data between the mobile financial application software program and the master financial application software program.

2. The method of claim 1 wherein the connection between the mobile financial application software program and the master financial application software program includes a wireless network.

3. The method of claim 2 wherein the connection between the mobile financial application software program and the master financial application software program further includes a wired network.

4. The method of claim 3 wherein the wired network is the Internet.

5. The method of claim 1 wherein the connection between the mobile financial application software program and the master financial application software program is a direct connection that does not include a network.

6. The method of claim 5 wherein the connection between the mobile financial application software program and the master financial application software program is a short range RF Bluetooth™ connection.

7. The method of claim 5 wherein the connection between the mobile financial application software program and the master financial application software program is an RF 802.11x connection.

8. The method of claim 5 wherein the connection between the mobile financial application software program and the master financial application software program is an infrared (IR) connection.

9. The method of claim 5 wherein the connection between the mobile financial application software program and the master financial application software program is a cabled connection.

10. The method of claim 1 wherein the financial data exchanged includes mobile e-commerce transactions conducted on the portable wireless device.

11. A method of exchanging personal financial data between a portable wireless device running a mobile financial application software program and a secure web-site residing on a network, the method comprising:
storing mobile e-commerce transactions using the mobile financial application software program;
establishing a connection between the mobile financial application software program and the web-site; and
exchanging financial data between the mobile financial application software program and the web-site.

12. The method of claim 11 wherein the connection between the mobile financial application software program and the web-site includes a wireless network.

13. The method of claim 12 wherein the connection between the mobile financial application software program and the web-site further includes a wired network.

14. The method of claim 13 wherein the wired network is the Internet.

15. The method of claim 11 wherein the financial data exchanged includes mobile e-commerce transactions conducted on the portable wireless device.

16. A computer program product for exchanging personal financial data between a portable wireless device running a mobile financial application software program and a master financial application software program residing on a separate computer, the computer program product comprising:
computer program code for storing mobile e-commerce transactions using the mobile financial application software program;
computer program code for establishing a connection between the mobile financial application software program and the master financial application software program; and
computer program code for exchanging financial data between the mobile financial application software program and the master financial application software program.

17. The computer program product of claim 16 wherein the financial data exchanged includes mobile e-commerce transactions conducted on the portable wireless device.

18. A system for exchanging personal financial data between a portable wireless device running a mobile financial application software program and a master financial application software program residing on a separate computer, the computer program product comprising:
means for storing mobile e-commerce transactions using the mobile financial application software program;
means for establishing a connection between the mobile financial application software program and the master financial application software program; and
means for exchanging financial data between the mobile financial application software program and the master financial application software program.

19. The system of claim 18 wherein the financial data exchanged includes mobile e-commerce transactions conducted on the portable wireless device.

20. A method of storing an e-commerce transaction in a portable wireless device comprising:
establishing a wireless connection between the portable wireless device and a service or goods provider for purposes of receiving services or goods from the service or goods provider;
receiving cost data for the service or goods desired;
processing the cost data against a financial database in the portable wireless device to determine whether to continue with the e-commerce transaction.
